(19) United States
(12) Patent Application Publication
(10) Pub. No.: US 2004/0190427 A1
(43) Pub. Date: Sep. 30, 2004

(54) Optical head

(76) Inventors: Tatsuro Ide, Kokubunji (JP); Takeshi Shimano, Tokorozawa (JP); Takeshi Nakao, Sagamihara (JP); Kazuo Shigematsu, Yoshikawa (JP)

Correspondence Address: ANTONELLI, TERRY, STOUT & KRAUS, LLP, 1300 NORTH SEVENTEENTH STREET, SUITE 1800, ARLINGTON, VA, 22209-9889, US

(21) Appl. No.: 10/642,210

(22) Filed: Aug. 18, 2003

(30) Foreign Application Priority Data
Mar. 25, 2003 (JP) 2003-081725

(51) Int. Cl. G11B 7/135

(52) U.S. Cl. 369/112.07; 369/121

(57) ABSTRACT

In an optical head for writing and reading data on optical discs (mainly CDs and DVDs) with various specifications using different light source wavelengths, the effective light beam size for the light from each light source differs. This leads to a drop in optical efficiency for the light of a narrower effective beam size. This problem is overcome by providing a dichroic beam expander between the light sources and an objective lens, the dichroic beam expander comprising a substrate with an N-stage step- or sawtooth-shaped blazed diffraction grating formed on both sides thereof. The size of the light beams from the two light sources with different wavelengths is increased or decreased in a wavelength-selective manner, so that the light from each light source can be utilized at high efficiencies.

### BACKGROUND OF THE INVENTION

1. Field of the Invention

The present invention relates to an optical head capable of writing and reading optical discs (recording media) of various specifications using different wavelengths, such as compact discs (CDs) and digital versatile discs (DVDs).

2. Background Art

Currently, optical recording media can be divided into CD-family optical discs and DVD-family optical discs. The former includes the conventional 0.65-GB discs such as CDs, CD-Rs, and CD-RWs. The latter includes DVDs, DVD-Rs, and DVD-RAMs that have achieved high densities, typically 4.7 GB. The wavelength of the light source (LD) in semiconductor lasers for writing and reading is about 780 nm for CD-family discs and about 650 nm for DVD-family discs, for example. The light source for the optical discs of about 25 GB, which are proceeding toward practical utilization as the next-generation large-capacity recording media, is expected to employ semiconductor lasers with about 400 nm wavelength. In order to allow for writing and reading such optical discs of various specifications with different write/read (W/R) wavelengths on a single optical disc drive apparatus, optical heads are being developed that include those with a plurality of light sources mounted on each optical head unit, so that the number of optical components as well as the size of the unit can be reduced.

The light beams emitted by a semiconductor laser are divergent, and their diverging angles are not uniform. Instead, the angles of emission of the output light are different between vertical and parallel directions to the plane of the emission layer, thereby creating an elliptical far-field pattern. In general, the angle of emission of laser beams emitted by a semiconductor laser is greater in a vertical direction than in a parallel direction, with the ratio of emission angles between the parallel and vertical directions ranging from approximately 1:2 to 1:4. The light spot focused on an optical recording medium should preferably be circular in shape, because the more elliptical the light spot is, the poorer the writing or reading performance tends to be.

Thus, in order to improve the optical efficiency in semiconductor lasers for optical discs of a single specification, JP Patent Publication (Kokai) No. 2002-319170 A (“Beam shaping element and optical head apparatus”) proposes a high-efficiency optical head apparatus. The optical head apparatus includes a beam shaping element comprised of two substrates that are arranged in parallel for changing the emission angles of output light from a semiconductor laser. At least one of the substrates has sawtooth- or step-shaped diffraction gratings formed thereon. The emission angles are varied by using first-order diffracted light of the diffracted light produced by the diffraction gratings such that the emission angles can substantially correspond to one another between the vertical and parallel directions.

JP Patent Publication (Kokai) No. 11-53755 (“Optical pickup apparatus”) proposes a holographic element for beam shaping in an optical pickup apparatus comprising two light sources with different emission wavelengths. The holographic element for beam shaping “expands” the intensity distribution of the elliptical shape of beams emitted by each light source only in the shorter-axis direction, thus obtaining a substantially circular intensity distribution and improving the recording and reproduction performance of the light emitted by each light source. The holographic element for beam shaping employs a polarizing hologram.

Further, JP Patent Publication (Kokai) No. 2000-163787 (“Compatible optical pickup apparatus”) proposes an optical pickup apparatus comprising two light sources with different emission wavelengths. In this apparatus, a step-shaped planar lens is disposed between each light source and an objective lens so that the light of a relatively long wavelength can be diffracted by the step-shaped planar lens toward the optical axis in order to improve the optical efficiency. In this optical pickup apparatus, the focal length of the light with a relatively long wavelength is extended, so that the lowering in the optical efficiency due to differences in numerical aperture NA of the objective lens can be prevented.

Writing or reading, particularly the former, data on optical discs requires a great amount of optical energy.

The beam shaping element in the apparatus disclosed in JP Patent Publication (Kokai) No. 2002-319170 A can deal with only one wavelength and is not designed to provide a high optical efficiency for two different wavelengths.

In JP Patent Publication (Kokai) No. 11-53755 A, optical elements such as a collimator lens and an objective lens are shared by output beams (laser beams) from two light sources provided in a single unit. In this case, the laser beam sizes and the focal lengths are substantially the same with only the numerical apertures NA of the objective lens different. As a result, the effective beam sizes with respect to the individual light sources vary, so that the light with a narrower effective beam size, i.e., the light corresponding to the objective lens with a smaller NA, has a low optical efficiency. Specifically, in a CD/DVD compatible optical head, for example, when the light from each light source with substantially identical beam sizes is incident on the objective lens, not all of the light for the CD with a smaller corresponding NA that is incident on the objective lens can be utilized, thus lowering the optical efficiency.

### SUMMARY OF THE INVENTION

It is therefore an object of the invention to provide an optical head capable of recording and reproducing optical discs with two different wavelengths, and that can provide a high optical efficiency for output lights from individual light sources.

In an optical head for writing and erasing or reading data, a dichroic beam expander is disposed between a first or a second light source and an objective lens for increasing or reducing the size of an output beam from the light source in shorter- and longer-axis directions of an elliptical cross-section of the beam. A dichroic beam expander comprises a substrate having step- or sawtooth-shaped blazed gratings formed on both sides thereof. It is used for increasing or decreasing the size of a beam, or allowing it to pass therethrough with substantially the same optical size, using a first-order diffracted light or a zero-order light produced by the blazed gratings.

As described above, a very high optical efficiency is required for output light from light sources with two different wavelengths. Thus, the depth of the grooves in the step- or sawtooth-shaped blazed gratings on both sides of the substrate of the dichroic beam expander is designed such that a phase grating that satisfies the following equation is obtained:

(n₂−n₁)d>λ₁

where d is the depth of the grating grooves, n2 is the refractive index of the phase grating, n1 is the refractive index of the area around the phase grating, and λ₁ is the wavelength of the longer wavelength. In this way, the optical efficiency of the output light from each light source is optimized in a compatible manner. The depth d refers to that of the deepest groove in the dichroic beam expander.

The “phase difference” refers to the difference in optical path lengths between the two light beams (I, II) emitted by one light source as shown in FIGS. 1(a) and (b), expressed in units of angles. When no object of comparison is specified, the phase difference refers to the difference in phase with respect to light beam (I) that passes through the deepest groove. The deepest groove is the groove whose depth is the greatest when looked at from the light output side. For example, a “phase difference θₖ due to step k” refers to the phase difference between light beam (I) passing through the deepest groove and light beam (II) passing through the kth step of the step-shaped grating. The “one wavelength” refers to the longest one of a plurality of wavelengths.

The meaning of the above expression (n₂−n₁)d>λ₁ will be explained. n₂ is the refractive index of the medium of the phase grating, n₁ is the refractive index of the medium around the phase grating. The regions around the phase grating may be atmosphere or filled with some kind of substance. As shown in FIG. 1(c), in the case of a step-shaped phase grating, the difference in the optical path lengths between a first optical path and a second optical path is made greater than one wavelength. The first optical path has groove depth d where the light with the longer wavelength λ₁ passes through the deepest portion (the bottom surface of the phase grating). In other words, it is the optical path in the medium with refractive index n₁ and groove depth d. The second optical path has depth d passing through the originating point (the upper-most surface of the phase grating) of the groove depths. It is therefore the optical path passing through the medium with refractive index n₂ and length d. Likewise, in the case of a sawtooth-shaped phase grating as shown in FIG. 1(d), the difference in optical path lengths between first and second optical paths is made greater than one wavelength. The first optical path has depth d where the light with longer wavelength λ₁ passes through the deepest portion (lowest position) of the phase grating. It is the optical path with depth d in the medium with refractive index n₁). The second optical path has length d and passes through the originating point of the grooves (the upper-most surface of the phase grating), namely the optical path with length d passing through the medium with refractive index n₂.

There is a groove depth that would maximize the diffraction efficiency of the blazed grating depending on the wavelength and on the order of diffraction utilized, and such groove depths for the individual light sources do not necessarily correspond. Namely, a groove depth that would maximize the optical efficiency for one wavelength could make it impossible for the other wavelength to have a desired optical efficiency. No apparent change is produced when light is provided with an optical path that is an integer multiple of the wavelength of the light. Therefore, by adding an optical path that is an appropriate integer multiple of the wavelength to the light from each light source, the diffraction efficiency can be roughly optimized for both lights. Thus, the optical utilization efficiencies for the output lights from the individual light sources can be optimized in a compatible manner.

By using such a dichroic beam expander, the emission distribution of the light source (LD) with any far-field pattern can be changed to a desired shape, so that the laser beam from the light source can be efficiently utilized.

At the currently commercialized product level, the output power of the semiconductor lasers is on the order of 230 mW for CDs and 100 mW for DVDs. The power incident into the disc which is required for recording is about 60 mW for CDs and 20 mW for DVDs. Assuming that the collimation efficiency for the output light from each light source is about 60% and that the optical efficiency of other optical components such as the objective lens is about 50%, the utilization ratio required for the conversion of the beam size is about 90% for CDs and about 70% for DVDs, which are very high efficiencies. By employing the features of the invention, optical utilization efficiencies of more than 90% for CDs and more than 70% for DVDs can be obtained.

In accordance with the invention, the phase difference is provided by means of the so-called “phase grating” so that the shape of the beam from a light source is changed. This technique is essentially different from the technique utilizing a “polarizing (diffraction) grating” disclosed in JP Patent Publication (Kokai) No. 11-53755 in which a phase difference is provided by difference in polarization directions.

Further, in accordance with the invention, the size of the beam from at least one of two or more light sources is appropriately changed by means of a dichroic beam expander. In contrast, in JP Patent Publication (Kokai) No. 2000-163787, the focal length of one light is varied in an attempt to prevent the decrease in optical efficiency, which is essentially different from the concept of the present invention.

### BRIEF DESCRIPTION OF THE DRAWINGS

FIG. 1 shows various views of a blazed grating for the explanation of a phase difference.

FIG. 2 shows an optical head according to a basic configuration of the invention.

FIG. 3(a) shows a side view of a dichroic beam expander comprising a substrate with a diffraction grating formed on both sides thereof.

FIG. 3(b) shows a side view of the diffraction grating formed on the surface of the substrate.

FIG. 3(c) shows a plane view of the blazed grating (with linear gratings).

FIG. 3(d) shows a plane view of the blazed grating (with elliptical gratings).

FIG. 3(e) shows a side view of a step-shaped blazed grating.

FIG. 4 shows the relationship between the number N of steps in the blazed grating and the zero and first-order maximum diffraction efficiencies.

FIG. 5 shows a dichroic beam expander according to the invention.

FIG. 6 shows examples of the structure of the blazed grating formed on the surface of the dichroic beam expander.

FIG. 7(a) shows how the light from a first LD is transmitted and that from a second LD is increased in size by the dichroic beam expander of the invention.

FIG. 7(b) shows how the light from the first LD is reduced in size and that from the second LD is transmitted by the dichroic beam expander.

FIG. 7(c) shows how the light from both LDs is reduced in size by the dichroic beam expander.

FIG. 7(d) shows how the light from the first LD is reduced in size and that from the second LD is increased in size by the dichroic beam expander.

FIG. 8 shows examples of the structure of the blazed grating formed on the surface of the dichroic beam expander.

FIG. 9 shows an example of the structure of the blazed grating formed on the surface of the dichroic beam expander.

FIG. 10 shows another embodiment of the optical head according to the invention.

FIG. 11 shows another embodiment of the optical head according to the invention.

FIG. 12 shows another embodiment of the optical head according to the invention.

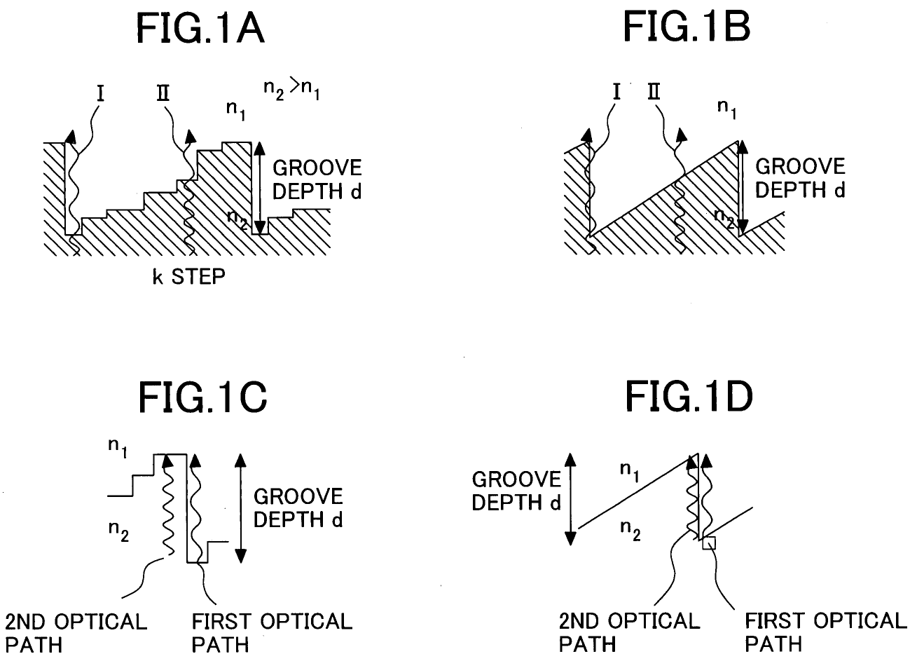

### DESCRIPTION OF THE PREFERRED EMBODIMENTS

The structure, operation and effects of the invention will be hereafter described by referring to the drawings.

(Embodiment 1)

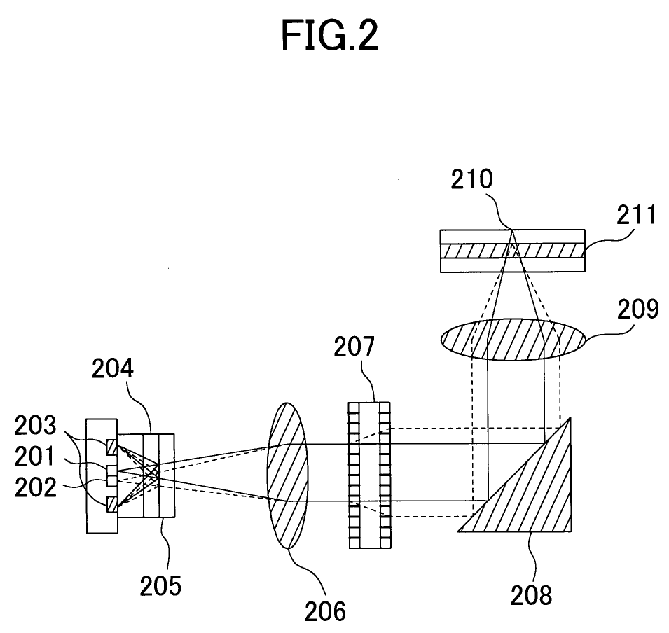

FIG. 2 schematically shows the structure of an optical head according to a first embodiment of the invention. A first light source LD 201, a second light source LD 202, and a photodetector element 203 as a detection means are disposed in a single can. Light emitted by LD 201 passes through a polarizing diffraction element 204 and then converted from a linearly polarized light into circularly polarized light by a so-called “quarter-wave plate” 205 that provides a phase difference substantially corresponding to ¼ wavelength. The converted light is collimated into substantially collimated light by a collimator lens 206. The light then passes through a dichroic beam expander 207, is reflected by a polarizing prism 208 and then focused by an objective lens 209 on a recording surface of a first optical disc 210 beyond the substrate. Light from LD 202 similarly passes through the polarizing diffraction element 204 and is then converted from linearly polarized light into circularly polarized light by the quarter-wave plate 205. The converted light is then collimated into collimated light by the collimator lens 206. After the size of the beam is increased by the dichroic beam expander 207, the light is reflected by the polarizing prism 208 and then focused on a second optical disc 211 by the objective lens 209. The light reflected by the optical discs 210 and 211 proceeds back the original optical path and is converted into linearly polarized light by the quarter-wave plate 205. At this point, the incident light and the reflected light from the disc have different polarization directions. Only the reflected light is diffracted by the polarizing diffraction element 204 that is so constructed. The diffracted light is then incident on the optical detector 203. The polarizing diffraction element 204 and the quarter-wave plate 205 are disposed between the first and second light sources 201 and 202 and the objective lens 209.

The function of the dichroic beam expander 207 will be described. In the following, it is assumed that, for the purpose of explanation, LD 201 is a semiconductor laser for CDs with wavelength λ₁=790 nm, and that LD 202 is a semiconductor laser for DVDs with wavelength λ₂=660 nm. The objective lens 209 is a CD/DVD compatible objective lens with different numerical apertures NA for LD 201 and 202. As mentioned above, when the optical elements such as collimator lens 206 and objective lens 209 are shared by the beams (laser beams) emitted by the two light sources LD 201 and LD 202, the incident beam sizes on the objective lens are substantially the same while the effective beam size for the light from each light source is different. As a result, the optical efficiency for the light with a narrower effective beam size, namely the light corresponding to an objective lens with a smaller NA, drops. Accordingly, the dichroic beam expander 207 is provided with the function of increasing or decreasing the size of the beam from each light source, or letting it pass therethrough as is, in a wavelength selective manner. In this way, the loss in light from each light source can be minimized, so that optical efficiency for each light can be optimized in a compatible manner. In Embodiment 1, the light from LD 201 is transmitted while the light from LD 202 is increased in size.

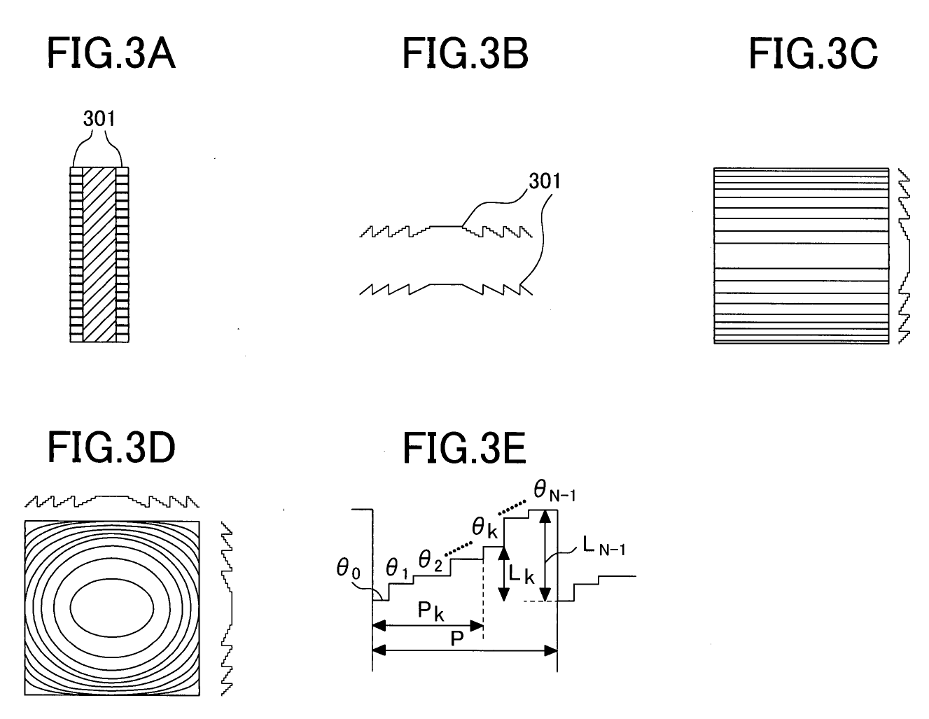

Regarding the specific structure of the dichroic beam expander 207, a step- or sawtooth-shaped blazed grating as shown in FIG. 3(b) is formed on both sides of a substrate, as shown in FIG. 3(a), in order to maximize the optical efficiency of the element. Alternatively, lenses may be formed on the surface of the substrate instead of the diffraction gratings. In Embodiment 1, in order to allow the substantially collimated light incident on the dichroic beam expander to be outputted as substantially collimated light, the diverging or converging light created by diffraction by the first blazed grating is made into substantially collimated light by the second blazed grating. The ratio of expansion or reduction of the size of the beam can be determined as desired by the pitch p of the blazed grating and the thickness d of the element's substrate. In an exemplary grating pattern, by forming the blazed grating with substantially linear lines as shown in FIG. 3(c), the size of the beam can be increased or decreased in a direction perpendicular to the lines. By making the grating elliptical in shape as shown in FIG. 3(d), the size of beam can be increased or decreased in two directions by appropriately setting the lengths of the shorter and longer axes of the oval. Further, by using a zero-order light without diffraction by the first and second blazed gratings, the incident beam on the dichroic beam expander can be caused to pass through with substantially the same beam size.

The operation of a single blazed grating will be described. The first-order diffracted light or zero-order light produced by the blazed grating based on the light from the two light sources LD 201 and 202 is used. In order to optimize the optical efficiency for both wavelengths in a compatible manner, phase differences θ¹ and θ² are provided to the light from the individual light sources (where 0≦θ¹, θ²<2π). These phase differences are (n+θ¹/2π)λ₁ and (m+θ²/2π)λ₂, respectively, which correspond to one wavelength or more. Integers n and m are selected such that the phase differences are equal as indicated by

$$( n + \frac{{θ}^{1}}{2 π} ) {λ}_{1} = ( m + \frac{{θ}^{2}}{2 π} ) {λ}_{2} \qquad ( 1 )$$

In a blazed grating with N-steps, when the line width up to step k is pk, and the phase difference provided by step k is θk as shown in FIG. 3(e), the complex amplitudes of the zero-order and ±first-order diffracted light can be expressed by

$$\begin{matrix}\begin{matrix}{R}_{0} = \frac{1}{p} \{ {\int }_{0}^{{p}_{1}} {ⅇ}^{ⅈ {θ}_{0}} ⅆ x + {\int }_{{p}_{1}}^{{p}_{2}} {ⅇ}^{ⅈ {θ}_{1}} ⅆ x + ⋯ + {\int }_{{p}_{N - 1}}^{p} {ⅇ}^{ⅈ {θ}_{N - 1}} ⅆ x \} \\ = \overline{{p}_{1}} + ( \overline{{p}_{2}} - \overline{{p}_{1}} ) {ⅇ}^{ⅈ {θ}_{1}} + ⋯ + ( 1 - \overline{{p}_{N - 1}} ) {ⅇ}^{ⅈ {θ}_{N - 1}} \\ = {\sum }_{k = 0}^{N - 1} ( \overline{{p}_{k + 1}} - \overline{{p}_{k}} ) {ⅇ}^{ⅈ {θ}_{k}}\end{matrix} \\ where \overline{{p}_{k}} ≡ \frac{{p}_{k}}{p} & ( 2 ) \\ \begin{matrix}{R}_{\pm 1} = \frac{1}{p} \{ {\int }_{0}^{{p}_{1}} {ⅇ}^{ⅈ {θ}_{0}} {ⅇ}^{\pm ⅈ \frac{2 π}{p} x} ⅆ x + {\int }_{{p}_{1}}^{{p}_{2}} {ⅇ}^{ⅈ {θ}_{1}} {ⅇ}^{\pm ⅈ \frac{2 π}{p} x} ⅆ x + ⋯ + \\ {\int }_{{p}_{N - 1}}^{p} {ⅇ}^{ⅈ {θ}_{N - 1}} {ⅇ}^{\pm ⅈ \frac{2 π}{p}} ⅆ x \} \\ = \frac{\pm 1}{2 π i} \{ ( {ⅇ}^{\pm ⅈ2 π \overline{{p}_{1}}} - 1 ) + ( {ⅇ}^{\pm ⅈ2 π \overline{{p}_{2}}} - {ⅇ}^{\pm ⅈ2 π \overline{{p}_{1}}} ) {ⅇ}^{ⅈ {θ}_{1}} + ⋯ + \\ ( 1 - {ⅇ}^{\pm ⅈ2 π \overline{{p}_{N - 1}}} ) {ⅇ}^{ⅈ {θ}_{N - 1}} \} \\ = \frac{\pm 1}{2 π i} {\sum }_{k = 0}^{N - 1} ( {ⅇ}^{\pm ⅈ2 π \overline{{p}_{k + 1}}} - {ⅇ}^{\pm ⅈ2 π \overline{{p}_{k}}} ) {ⅇ}^{ⅈ {θ}_{k}}\end{matrix} & ( 3 )\end{matrix}$$

In this case, the zero- and first-order diffraction efficiency η₀ and η_{±1} by the single N-stage blazed grating can be expressed by

$$\begin{matrix}{η}_{0} = {\vert {\sum }_{k = 0}^{N - 1} ( \overline{{p}_{k + 1}} - \overline{{p}_{k}} ) {ⅇ}^{ⅈ {θ}_{k}} \vert}^{2} \\ and & ( 4 ) \\ {η}_{\pm 1} = \frac{1}{4 {π}^{2}} {\vert {\sum }_{k = 0}^{N - 1} ( {ⅇ}^{\pm ⅈ2 π \overline{{p}_{k + 1}}} - {ⅇ}^{\pm ⅈ2 π \overline{{p}_{k}}} ) {ⅇ}^{ⅈ {θ}_{k}} \vert}^{2} & ( 5 )\end{matrix}$$

Generally, for a number N of complex numbers z₁, z₂, . . . z_{N},

$$\vert {\sum }_{k} {z}_{k} \vert \leq {\sum }_{k} \vert {z}_{k} \vert \qquad ( 6 )$$

in which the signs are valid when

arg(z₁)=arg(z₂)= . . . =arg(z_{N}) (7)

Thus, the maximum zero-order diffraction efficiency by the single N-stage blazed grating is expressed by

η_{0,max}=1 (8)

when

θₖ=0 (9)

The maximum first-order diffraction efficiency is expressed by

$$\begin{matrix}{η}_{\pm 1 , max} = {( \frac{N}{π} sin ( \frac{π}{N} ) )}^{2} \\ when & ( 10 ) \\ {p}_{k} = \frac{k}{N} , {θ}_{k} = ∓ k \frac{2 π}{N} & ( 11 )\end{matrix}$$

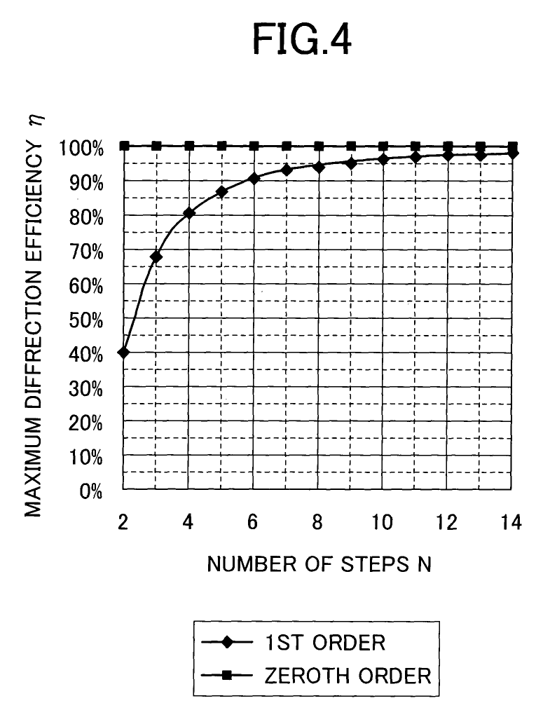

FIG. 4 shows the relationship between the number N of the steps of the blazed grating and the maximum zero- and first-order diffraction efficiencies. The maximum zero-order diffraction efficiency η_{0,max} is theoretically 100% regardless of the number of the steps in the blazed grating, whereas the maximum first-order diffraction efficiency η_{±,max} is a monotone increasing function (converging to 1). Namely, the maximum first-order diffraction efficiency can be increased by increasing the number N of the steps in the blazed grating. For example, in a blazed grating with N=6, the maximum first-order diffraction efficiency is 91.2%, while the optical efficiency of the dichroic beam expander with two blazed gratings is 83.2%.

In order to optimize the utilization efficiency of the lights from the two light sources in a compatible manner, it is necessary to satisfy equation (9) and/or equation (11) depending on the order of diffraction. In reality, in equation (1) integers n and m are selected such that equation (9) and/or equation (11) are satisfied as much as possible depending on the diffraction order of θ¹ and θ². However, it is impossible to completely satisfy equation (9) and/or equation (11). As a result, the zero-order and first-order diffraction efficiencies become lower than the theoretical maximum efficiencies expressed by equation (8) and equation (10). Accordingly, because the optical efficiency of the dichroic beam expander also drops, it is necessary to determine θ¹ and θ² appropriately by which the efficiencies can be optimized in a compatible manner. The line width pₖ up to step k does not influence the maximum zero-order diffraction efficiency η_{0,max} but influences the maximum first-order diffraction efficiency η_{±1,max}. Thus, in order to maximize the first-order efficiency,

$${p}_{k} = \frac{k}{N} \qquad ( 12 )$$

Namely, the width of each step is made substantially the same. With regard to the phase difference θₖ, when the groove depth of step k of the blazed grating is Lₖ as shown in FIG. 3(e), the refractive index of the substrate of the dichroic beam expander is n₂, and the refractive index of the surrounding medium is n₁,

$$( {n}_{2} - {n}_{1} ) {L}_{k} = ( n + \frac{{θ}_{k}^{1}}{2 π} ) {λ}_{1} = ( m + \frac{{θ}_{k}^{2}}{2 π} ) {λ}_{2} \qquad ( 13 )$$

Here, θₖ¹ and θₖ² are defined as the phase differences provided by the kth step to the light from the first and second light sources, respectively. Thus, the groove depth Lₖ of the blazed grating is determined by selecting appropriate integers n and m in each step such that the phase differences θₖ¹ and θₖ² satisfy equation (9) and/or equation (11) as much as possible for the two wavelengths depending on the order of diffraction utilized. In Embodiment 1, the light from LD 201 is transmitted and the light from LD 202 is enlarged, so that equation (13) becomes

$$( {n}_{2} - {n}_{1} ) {L}_{k} = n {λ}_{1} = ( m - \frac{k}{N} ) {λ}_{2} \qquad ( 14 )$$

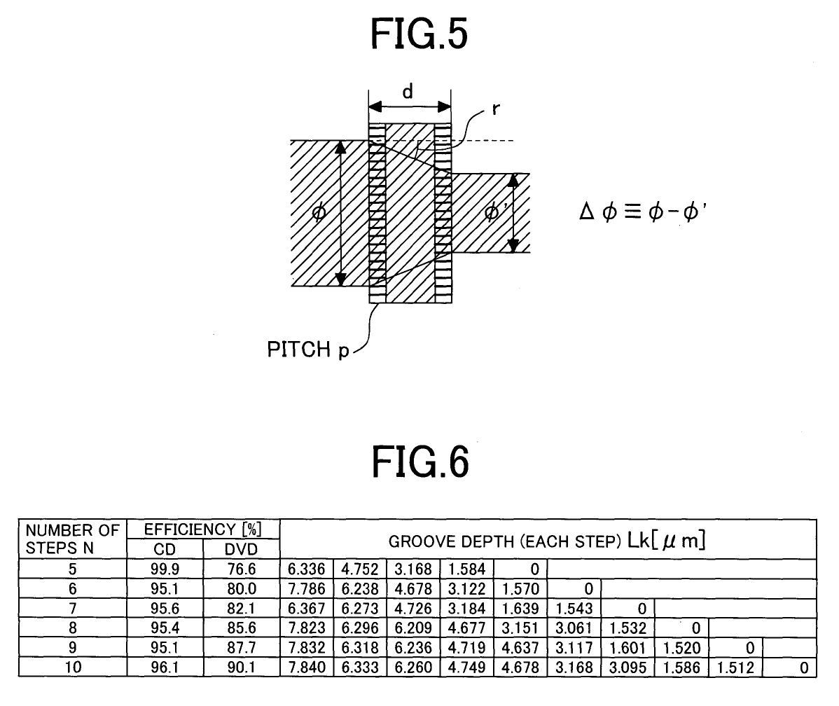

With regard to pitch p of the blazed grating and thickness d of the dichroic beam expander, as shown in FIG. 5, when the wavelength of the light from a light source is λ the variation in the beam size due to the dichroic beam expander is Δφ, and the diffraction angle is r, the following conditional expressions can be obtained:

psinr=λ (15)

and

$$d tan r = \frac{1}{2} Δ φ \qquad ( 16 )$$

When the variation (Δφ) in size of the beam is determined, one of pitch p of the blazed grating or thickness d of the element can be determined by giving the value of the other.

In the following, Embodiment 1 will be further described by using specific values. FIG. 6 shows various values of in the dichroic beam expander that can provide the optical utilization efficiencies of more than 90% for CDs and more than 70% for DVDs in the case where the refractive index of the dichroic beam expander element n₂=1.5 and the refractive index of the surrounding area n₁=1.0, For example, when N=5 and the depths of the steps are 6.336 μm, 4.752 μm, 3.168 μm, and 1.584 μm, the DBE (dichroic beam expander) efficiency is 99.9% for CDs and 76.6% for DVDs, so that the beam size can be changed in a wavelength-selective manner while maintaining high efficiencies for both kinds of light. The DBE efficiency for DVDs can be further improved by increasing the number N of steps, as shown in FIG. 6. While in the examples listed in FIG. 6 the number N of steps in the blazed grating is not more than 10 from the viewpoints of ease of manufacture and cost, it is possible to obtain higher efficiencies by increasing N.

In the present embodiment, LD 201 is a semiconductor laser for CDs with wavelength λ₁=790 nm and LD 202 is a semiconductor laser for DVDs with wavelength λ₂=660 nm for ease of explanation. However, various other combinations of wavelengths may be employed, such as λ₁=790 nm and λ₂=410 nm, or λ₁=660 nm and λ₂=410 nm, for example.

(Embodiment 2)

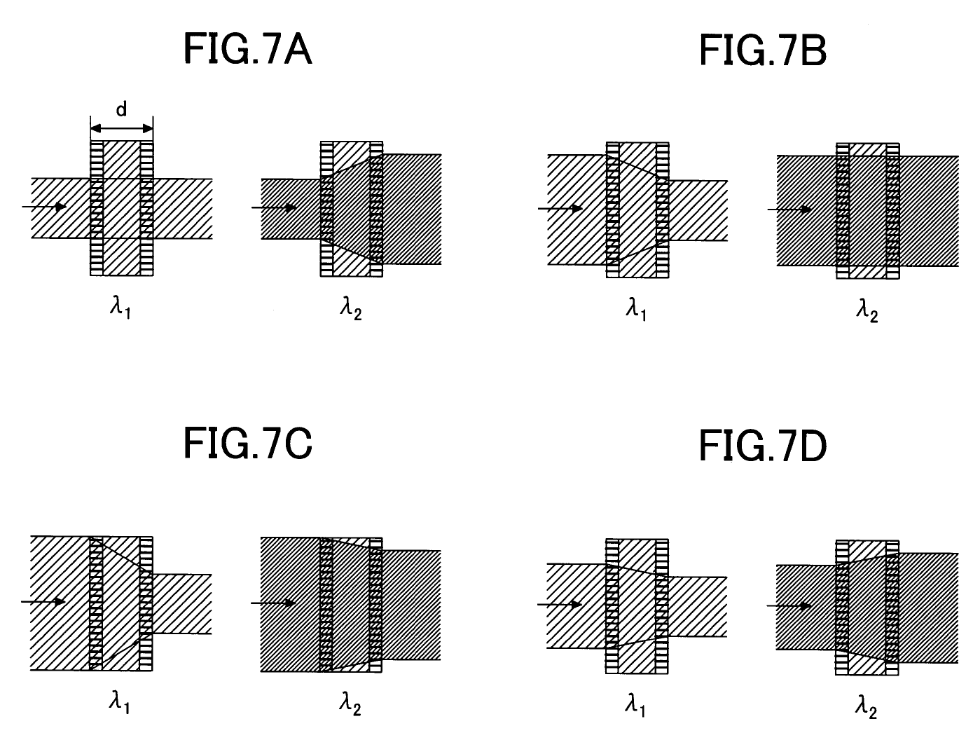

In Embodiment 1, the light from LD 201 is transmitted and the light from LD 202 is enlarged, as shown in FIG. 7(a). In Embodiment 2, the light from LD 201 is reduced in size while the light from LD 202 is transmitted by dichroic beam expander 207, as shown in FIG. 7(b). In this embodiment, the pattern on the blazed grating is determined by

$$( {n}_{2} - {n}_{1} ) {L}_{k} = ( n + \frac{k}{N} ) {λ}_{1} = m {λ}_{2} \qquad ( 17 )$$

Other specifics are substantially similar to those of Embodiment 1 and will therefore not be described in detail.

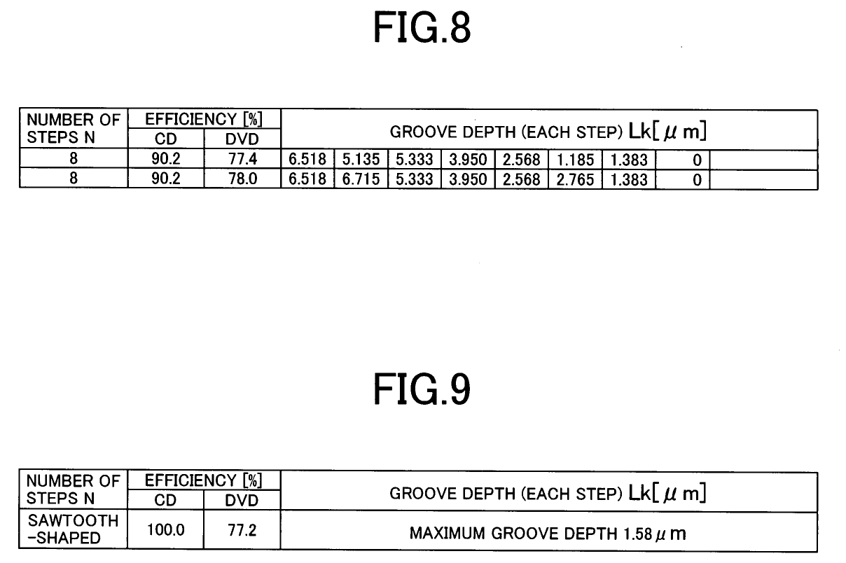

Embodiment 2 will be further described by referring to specific values. FIG. 8 shows specific values of the dichroic beam expander that can provide the optical efficiency of more than 90% for CDs and more than 70% for DVDs in the case where the refractive index of the dichroic beam expander element n₂=1.5 and that of the surrounding area n₁=1.0, as in Embodiment 1. For example, when N=8 and the maximum groove depth is about 6.5 μm, the DBE efficiencies is 90.2% for CDs and 77.4% for DVDs.

(Embodiment 3)

In Embodiment 3, the lights from both LD 201 and LD 202 are reduced in size by dichroic beam expander 207, as shown in FIG. 7(c). In this embodiment, the pattern on the blazed grating is determined by

$$( {n}_{2} - {n}_{1} ) {L}_{k} = ( n + \frac{k}{N} ) {λ}_{1} = ( m + \frac{k}{N} ) {λ}_{2} \qquad ( 18 )$$

Other specifics are substantially similar to those of Embodiment 1 and therefore will not be described in detail.

Embodiment 3 will be further described by referring to specific values. FIG. 9 shows a specific value of the dichroic beam expander that can provide optical efficiency of more than 90% for CDs and more than 70% for DVDs in the case where the refractive index of the dichroic beam expander element n₂=1.5 and that of the surrounding area n₁=1.0. In Embodiment 3, the DBE efficiencies is 100% for CDs and 77.2% for DVDs in the case where the blazed grating is sawtooth-shaped with the maximum groove depth of 1.58 μm.

(Embodiment 4)

In the optical head of Embodiment 1, the light from LD 201 may be reduced in size by the dichroic beam expander 207 while enlarging the light from LD 202. In Embodiment 4, the pattern on the blazed grating is determined by

$$( {n}_{2} - {n}_{1} ) {L}_{k} = ( n + \frac{k}{N} ) {λ}_{1} = ( m - \frac{k}{N} ) {λ}_{2} \qquad ( 19 )$$

Other specifics are substantially similar to those described with reference to Embodiment 1 and therefore will not be described in detail.

(Embodiment 5)

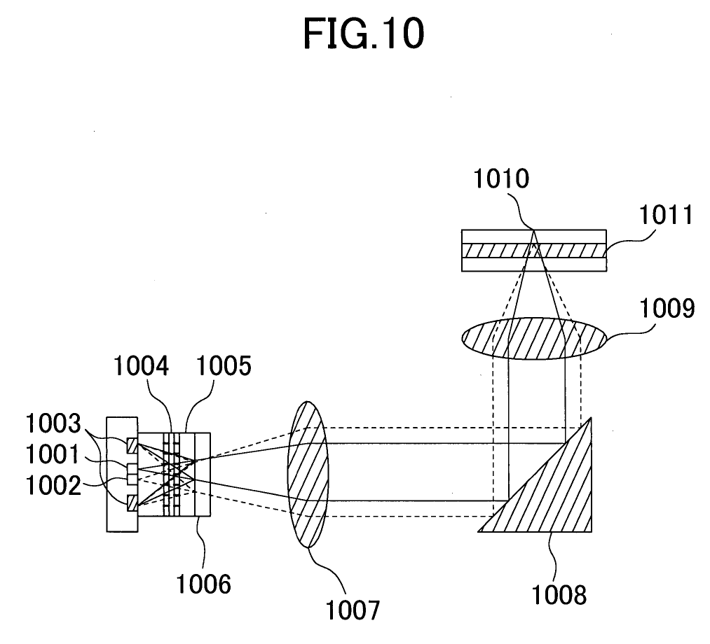

FIG. 10 schematically shows the optical head according to the fifth embodiment of the invention. A first light source LD 1001, a second light source LD 1002, and a photodetector element 1003 as a detector are disposed in a single can. The light from LD 1001 has its beam size increased or reduced by a dichroic beam expander 1004 or is let pass therethrough as is. The light then passes through a polarizing diffraction element 1005 and is then converted from linearly polarized light into circularly polarized light by a quarter-wave plate 1006 that provides a substantially ¼ wavelength phase difference. The circularly polarized light is then collimated into collimated light by a collimator lens 1007, reflected by a deflection prism 1008, and then focused by an objective lens 1009 on a recording surface of a first optical disc 1010 via a substrate. The light from LD 1002 similarly has its beam size increased or reduced by dichroic beam expander 1004 or is let pass therethrough as is. The light passes through polarizing diffraction element 1005 and is then converted from linearly polarized light into circularly polarized light by quarter-wave plate 1006. The circularly polarized light is reflected by deflection prism 1008 and then focused by objective lens 1009 on a second optical disc 1011. The light reflected by optical discs 1010 and 1011 proceeds back along the original optical path and converted back to linearly polarized light by quarter-wave plate 1006. At this point, the incident light and the reflected light from the disc have different polarization directions. Only the reflected light is diffracted by polarizing diffraction element 1005 that is so constructed. The diffracted light is then incident on photodetector 1003. Polarizing diffraction element 1005 and quarter-wave plate 1006 are disposed between the first and second light sources 1001 and 1002 and the objective lens 1009. In Embodiment 1, the dichroic beam expander is disposed in the substantially collimated light from the first and second light sources. In Embodiment 5, the dichroic beam expander is disposed in the divergent light from the first and second light sources. When the angle of incidence of the output light from the light source on the dichroic beam expander is i, equation (15) merely becomes

p(sinr−sini)=λ (20)

and the shape of the dichroic beam expander can be determined basically in the same manner as in Embodiments 1 to 4. Further, the optical head can be made smaller in size by putting a laser module consisted of first and second light sources LD 1001 and LD 1002 and detector 1003 contained in the same can, dichroic beam expander 1004, polarizing diffraction element 1005, and quarter-wave plate 1006 together in a single unit. In this manner, the need for optical axis adjustments for each element can be eliminated, so that the reliability of the optical head can be increased.

By constructing a single module consisting of the light sources, detector, and the dichroic beam expander as shown in FIG. 10, the size of the optical bead can be reduced. As the number of discrete components decreases, relative positional variations among the components can be reduced, thus increasing the reliability of the optical head.

(Embodiment 6)

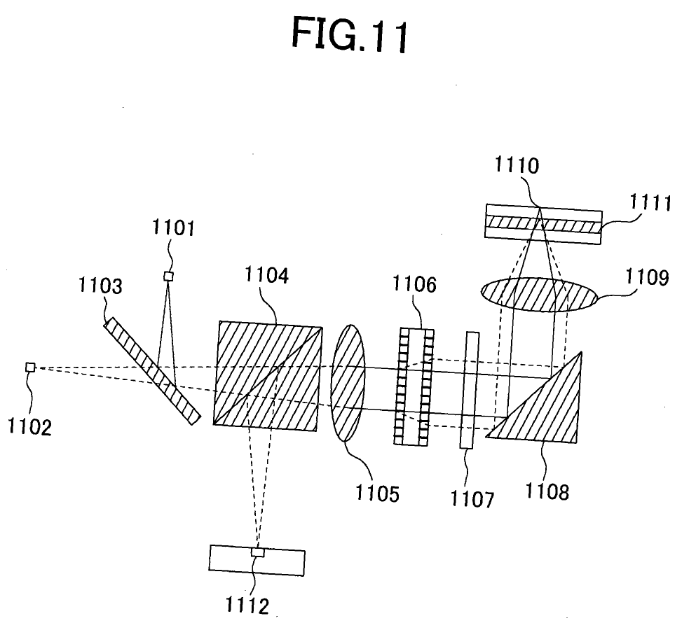

FIG. 11 schematically shows the optical head according to a sixth embodiment of the invention. In Embodiment 6, the phase grating is disposed in collimated light. Numeral 1101 designates a first light source and 1102 a second light source. The light from LD 1101 is reflected by a dichroic mirror 1103 and then passes through a beam splitter 1104. The light is then collimated into collimated light by a collimator lens 1105. The size of the light beam is increased or reduced by a dichroic beam expander 1106 or is let pass therethrough as is. The light is then converted from linearly polarized light into circularly polarized light by a quarter-wave plate 1107 that provides a phase difference substantially corresponding to a ¼ wavelength. The circularly polarized light is reflected by a deflection prism 1108 and is then focused by an objective lens 1109 on a recording surface of a first optical disc 1110 via a substrate. The light from LD 1102 also passes through dichroic mirror 1103 and beam splitter 1104 and is collimated into collimated light by collimator lens 1105. The size of the beam is increased or reduced by dichroic beam expander 1106 or is let pass therethrough as is. The light is then converted from linearly polarized light into circularly polarized light by quarter-wave plate 1107. The circularly polarized light is reflected by deflection prism 1108 and then focused by objective lens 1109 on a second optical disc 1111. The light reflected by optical discs 1110 and 1111 proceeds back along the original optical path and is then converted back to linearly polarized light by quarter-wave plate 1107. At this time, the incident light and the reflected light from the disc have different polarization directions. Accordingly, only the reflected light is reflected by beam splitter 1104 that is so constructed, and the reflected light is then incident on a photodetector 1112. The quarter-wave plate is located between beam splitter 1104 and objective lens 1109. In Embodiment 6, the dichroic beam expander is disposed in the substantially collimated light from the first and second light sources. The shape of the dichroic beam expander can be determined in the same manner as in Embodiments 1 to 4.

(Embodiment 7)

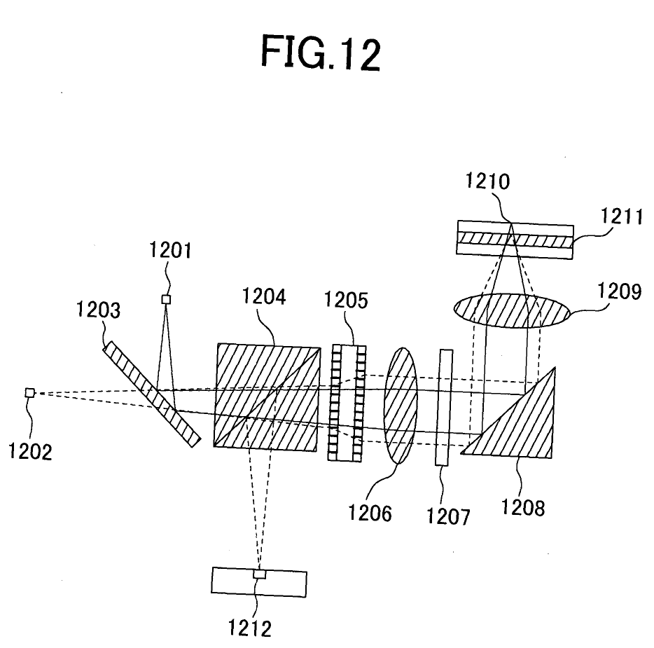

FIG. 12 schematically shows the optical head according to a seventh embodiment of the invention. In Embodiment 7, the phase grating is disposed in divergent light. Numeral 1201 designates a first light source LD and numeral 1202 a second light source LD. The light from LD 1201 is reflected by a dichroic mirror 1203 and then passes through a beam splitter 1204. The size of the beam is increased or decreased by a dichroic beam expander 1205 or is let pass therethrough as is. The light is then collimated into collimated light by a collimator lens 1206 and then converted from linearly polarized light into circularly polarized light by a quarter-wave plate 1207 that provides a phase difference substantially corresponding to a ¼ wavelength. The circularly polarized light is then reflected by a deflection prism 1208 and then focused by an objective lens 1209 on a recording surface of a first optical disc 1210 via a substrate. The light from LD 1202 similarly passes through dichroic mirror 1203 and beam splitter 1204. The size of the beam is increased or decreased by dichroic beam expander 1205 or is let pass therethrough as is. The light is then collimated into collimated light by collimator lens 1206 and then converted from linearly polarized light into circularly polarized light by quarter-wave plate 1207. The circularly polarized light is reflected by deflection prism 1208 and then focused by objective lens 1209 on a second optical disc 1211. The light reflected by optical discs 1210 and 1211 proceeds back along the original optical path and converted back into linearly polarized light by quarter-wave plate 1207. At this point, the incident light and the reflected light from the disc have different polarization directions. Accordingly, only the reflected light is reflected by beam splitter 1204 that is so constructed, and the reflected light is then incident on a photodetector 1212. The quarter-wave plate is located between beam splitter 1204 and objective lens 1209. In Embodiment 7, the dichroic beam expander is disposed in the substantially collimated light from the first and second light sources. The shape of the dichroic beam expander can be determined in the same manner as in Embodiment 5.

Thus, in accordance with the invention, an optical head with at least one light source can be realized in which no matter what the far-field pattern of the light source is, the emission distribution of the light source can be modified into a desired shape while maintaining a high level of optical efficiency. Accordingly, the optical head according to the invention can read and write information on optical recording media with different standards at high speeds.

What is claimed is:

1. An optical head comprising:
a first light source for generating light with a first wavelength λ₂;
a second light source for generating light with a second wavelength λ₁ that is shorter than the first wavelength;
an objective lens for converging the light from the first light source and the light from the second light source; and
a phase grating disposed between the objective lens and the first or second light source for increasing or decreasing the size of the beam of light of at least one of the first and second wavelengths, the phase grating having a groove with a depth d, wherein the phase grating satisfies (n₂−n₁)d>λ₁, where n₂ is the refractive index of the phase grating and n₁ is the refractive index of the areas around the phase grating.

2. The optical head according to claim 1, wherein the phase grating increases or decreases the size of the beam of light from at least one of the first and second light sources in shorter-axis and longer-axis directions with different magnifications.

3. The optical head according to claim 1, wherein the phase grating satisfies:
$$( n + \frac{{θ}^{1}}{2 π} ) {λ}_{1} = ( m + \frac{{θ}^{2}}{2 π} ) {λ}_{2}$$
where n and m are integers, θ¹ is a phase difference provided to the first wavelength, and θ² is a phase difference provided to the second wavelength.

4. The optical head according to claim 1, wherein the phase grating comprises a substrate having a step- or sawtooth-shaped blazed grating formed on both sides thereof.

5. The optical head according to claim 4, wherein, of the diffraction light produced by the blazed grating, a zero-order or first-order diffraction light is used.

6. The optical head according to claim 1, wherein the phase grating comprises a first grating for increasing the size of the beam of at least one of the first and second wavelengths, and a second grating for reducing the size of the thus increased size of the beam.

7. The optical head according to claim 1 wherein the phase grating comprises a first grating for reducing the size of the beam of at least one of the first and second wavelengths, and a second grating for increasing the thus reduced size of the beam.

8. The optical head according to claim 1, wherein the phase grating does not change the size of the beam of the first wavelength.

9. The optical head according to claim 1, wherein the phase grating does not change the size of the beam of the second wavelength.

10. The optical head according to claim 1, wherein the phase grating reduces the size of the beams of both the first and second wavelengths.

11. The optical head according to claim 1, wherein the phase grating reduces the size of the light of the first wavelength while increasing the size of the light of the second wavelength.

12. The optical head according to claim 1, wherein the first wavelength is about 780 nm and the second wavelength is about 650 nm.

13. The optical head according to claim 1, wherein the phase grating is disposed in the optical path of divergent light.

14. The optical head according to claim 1, wherein the phase grating is disposed in the optical path of collimated light.

15. The optical head according to claim 1, wherein the optical head is a recording head for recording information on a recording medium using the light of the first and second wavelengths.

16. An optical head comprising:
a module including a first light source for generating light of a first wavelength λ₁ and a second light source for generating light of a second wavelength λ₂ that is shorter than the first wavelength;
an objective lens for converging the light from the first light source and the light from the second light source; and
a phase grating disposed between the objective lens and the first or second light source for increasing or decreasing the size of the beam of light of at least one of the first and second wavelengths, the phase grating having a groove with a depth d, wherein the phase grating satisfies (n₂−n₁)d>λ₁, where n₂ is the refractive index of the phase grating and n₁ is the refractive index of the areas around the phase grating.

17. The optical head according to claim 16, wherein the phase grating is integrally formed with the module.
